(19) United States
(12) Patent Application Publication
(10) Pub. No.: US 2023/0095810 A1
(43) Pub. Date: Mar. 30, 2023

(54) User Authentication Using Biometric and Motion-Related Data of a User Using a Set of Sensors

(71) Applicant: Apple Inc., Cupertino, CA (US)

(72) Inventors: Hojjat Seyed Mousavi, Santa Clara, CA (US); Behrooz Shahsavari, Hayward, CA (US)

(21) Appl. No.: 17/831,278

(22) Filed: Jun. 2, 2022

Related U.S. Application Data
(60) Provisional application No. 63/248,021, filed on Sep. 24, 2021.

(51) Int. Cl. G06K 9/62; G06N 3/04; G06N 3/08; G06F 3/01; G06F 21/31

(52) U.S. Cl. CPC G06K 9/629; G06N 3/04; G06N 3/08; G06K 9/6289; G06F 3/015; G06F 21/31

(57) ABSTRACT

A method for authenticating a user is disclosed. The method includes collecting, by a processor of an electronic device and while the electronic device is worn by a user, measurement data from a set of sensors of the electronic device. The method also includes providing, by the processor and to a machine-learning model, the collected measurement data from the set of sensors and previously collected sets of measurement data for a known user. The method also includes obtaining, by the processor, an indication of whether an extracted feature set is similar to one of a number of classified feature sets. At least one of the classified feature sets is classified as belonging to the known user and generated based on the previously collected sets of measurement data for the known user. The method also includes determining, by the processor, whether the user is the known user based on the obtained indication.

### CROSS-REFERENCE TO RELATED APPLICATION

This application is a non-provisional of and claims the benefit under 35 U.S.C. § 119(e) of U.S. Provisional Patent Application No. 63/248,021, filed Sep. 24, 2021, and titled “User Authentication Using Biometric Data from a Network of Sensors,” the contents of which are incorporated herein by reference, as if fully disclosed herein, for all purposes.

### FIELD

Embodiments described herein generally relate to authentication of a user of an electronic device using biometric and motion-related data of the user.

### BACKGROUND

An electronic device, for example a wearable electronic device like a watch, and so on, allows access to various features and/or applications on the electronic device after a user successfully authenticates herself. The user may be authenticated using, for example, a password, a personal identification number (PIN), a design pattern, recognition of bodily features such as a face or iris of the eye, and so on. Disadvantages of these methods include, for example, that the password, PIN, and/or the design pattern may be known to a person other than the user of the electronic device; facial recognition may require the user to uncover their face and/or eye shield; and so on. Accordingly, currently known methods of authenticating a user on the wearable electronic device pose a substantial privacy and security risk.

### SUMMARY

Embodiments described herein generally relate to an electronic device and, in particular, authenticating a user of the electronic device, based on measurement data collected from two or more sensors of a set of sensors. The two or more sensors may be disposed interior to the electronic device and/or on a surface of the electronic device.

In one embodiment, a method is disclosed. The method may include collecting, by a processor of an electronic device and while the electronic device is worn by a user, measurement data from a set of sensors of the electronic device. The method may also include providing, by the processor and to a machine-learning model, the collected measurement data from the set of sensors and previously collected sets of measurement data for a known user. The machine-learning model may extract a feature set from a fusion of the measurement data obtained by the set of sensors and determine a similarity of the feature set to each of a number of classified feature sets. The classified feature sets may be generated based on classified measurement data. The method may also include obtaining, by the processor, an indication of whether the extracted feature set is similar to one of the classified feature sets. At least one of the classified feature sets may be classified as belonging to the known user and may be generated based on the previously collected sets of measurement data for the known user. The method may also include determining, based on the obtained indication and by the processor, whether the user is the known user.

In another embodiment, a wearable electronic device is disclosed. The wearable electronic device may include a memory configured to store instructions, a set of sensors including at least two sensors, and a processor. The processor may be configured to execute the instructions stored in the memory, which causes the processor to perform operations including collecting measurement data from the set of sensors while the wearable electronic device is worn by a user. The operations may also include providing, to a trained machine-learning model, the collected measurement data from the set of sensors and previously collected sets of measurement data for a known user. The trained machine-learning module may extract a feature set from a fusion of the measurement data obtained by the set of sensors and determine a similarity of the feature set to each of a number of classified feature sets. The classified feature sets may be generated based on classified measurement data. The operations may also include determining whether the user is the known user based on a comparison of the extracted feature set with each of the number of classified feature sets. At least one of the number of classified feature sets may be classified as belonging to the known user and may be generated based on the previously collected sets of measurement data for the known user.

In yet another embodiment, a system is disclosed. The system may include a first wearable electronic device including at least one PhotoPlethysmoGraphy (PPG) sensor, a second wearable electronic device including at least one Inertial Measurement Unit (IMU) sensor, and a processor. The processor may be configured to collect measurement data from the at least one PPG sensor and the at least one IMU sensor while the first and second wearable electronic devices are worn by a user, and provide, to a machine-learning model, the collected measurement data from the set of sensors and previously collected sets of measurement data for the known user. The machine-learning model may be trained to extract a feature set from a fusion of measurement data obtained by the set of sensors and determining a similarity of the feature set to each of a number of classified feature sets. The classified feature sets may be generated based on classified measurement data, wherein at least one of the classified feature sets may be classified as belonging to a known user. The processor may also be configured to determine whether the user is the known user based on a comparison of the extracted feature set with each of the number of the classified feature sets. At least one of the number of classified feature sets may be classified as belonging to the known user and may be generated based on the previously collected sets of measurement data for the known user.

### BRIEF DESCRIPTION OF THE DRAWINGS

Reference will now be made to representative embodiments/aspects illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1A depicts a front view of an example wearable electronic device.

FIG. 1B depicts a back view of the wearable electronic device shown in FIG. 1A.

FIG. 2 depicts an example block diagram of the wearable electronic device shown in

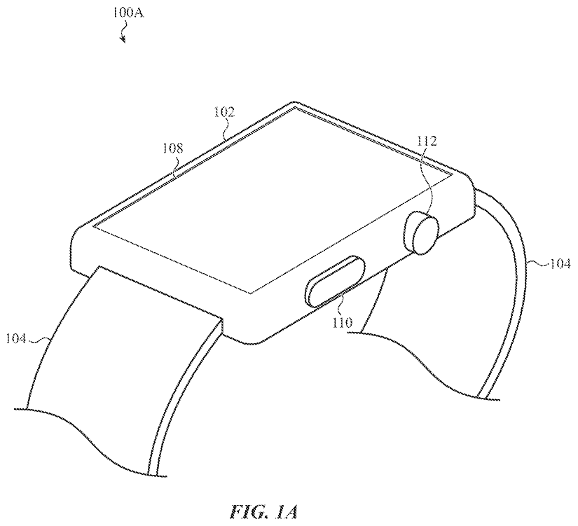

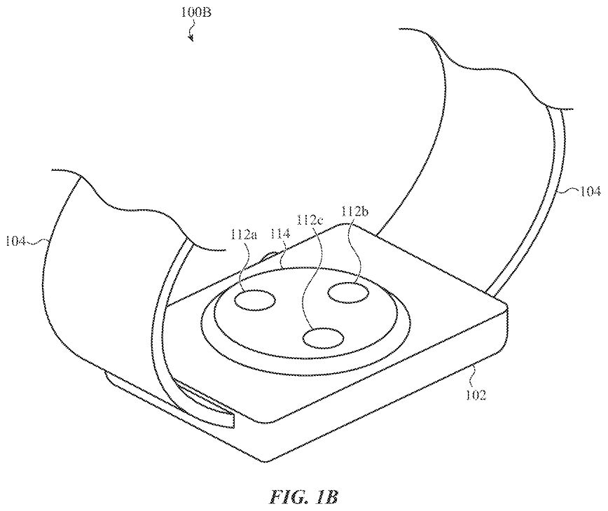

FIG. 1A and FIG. 1B, in accordance with some embodiments.

FIGS. 3A-3B depict an example use case of authenticating a user based on measurement data collected from a set of sensors, in accordance with some embodiments.

FIG. 4A depicts a feature extractor architecture, in accordance with some embodiments.

FIG. 4B depicts an example process flow of sensor data of the feature extractor architecture shown in FIG. 4A, in accordance with some embodiments.

FIG. 4C depicts an example machine-learning model of the feature extractor architecture shown in FIG. 4A, in accordance with some embodiments.

FIG. 4D depicts an example neural network and, in particular, a Siamese neural network, of the feature extractor architecture shown in FIG. 4A, in accordance with some embodiments.

FIG. 5 depicts an example flow chart depicting operations for authenticating a user based on fusion of measurement data from a set of sensors, in accordance with some embodiments.

The use of the same or similar reference numerals in different figures indicates similar, related, or identical items. Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments/aspects illustrated in the accompanying drawings. It should be understood that the following description is not intended to limit the embodiments to one preferred embodiment. On the contrary, it is intended to cover alternatives, combinations, modifications, and equivalents as can be included within the spirit and scope of the described embodiments as defined by the appended claims.

Embodiments described herein relate to authentication of a user of an electronic device using biometric and motion data of the user. The biometric and motion data may be collected using a set of sensors disposed interior to, and/or on a surface of, a housing of the electronic device. The set of sensors may include a variety of sensors, for example, a PhotoPlethysmoGraphy (PPG) sensor, an Inertial Measurement Unit (IMU) sensor, a temperature sensor, an ElectroCardioGram (ECG) sensor, a heartrate sensor, and so on.

The PPG sensor may be used to measure a change in blood volume corresponding to a heart activity of a user. The heart activity of the user may vary according to a physical activity being performed by a user. Each user may, therefore, have a different pattern of heart activity corresponding to the same physical activity. Further, in most cases, the user may also have a pattern of the physical activity based on time of the day, and/or a day of the week, and so on. Accordingly, measured heart activity using the PPG sensor may be used to authenticate the user.

Data collected from the PPG sensors may help identify different users, and, therefore, data collected from a PPG sensor may be used for authentication of the user. However, data collected from the PPG sensor may exhibit random behavior, being prone to movements affecting heart activity. Accordingly, in some embodiments, data collected from the PPG sensor and data collected from one or more other types of sensors may be used collectively to authenticate the user.

For example, in some embodiments, data from the PPG sensor may be used along with data collected from the IMU sensor. The IMU sensor may be an accelerometer and/or a gyroscope. The IMU sensor may be used to capture motion or movement of the user. Similar to the heart activity, each user may also have a differentiating motion or movement pattern. Accordingly, data from the PPG sensor and the IMU sensor may be collectively used to reduce the randomness of the pattern while using data from the PPG sensor or the IMU sensor alone.

In some embodiments, and by way of a non-limiting example, data collected using other types of sensors, such as the temperature sensor, the heartrate sensor, and/or the ECG sensor, and so on, may be used in combination with data from an IMU sensor to reduce the randomness of the behavior.

In some embodiments, a user may be authenticated using biometric and/or motion data collected from a set of sensors included in a wearable electronic device using a machine-learning model that is trained to extract a feature set from a fusion of measurement data obtained from the set of sensors. In the present disclosure, the fusion of measurement data suggests measurement data from different types of sensors are collectively used to extract a feature set that uniquely identifies a user. For example, as described herein, each user may have a unique heartrate pattern associated with a particular movement activity. Thus, a fusion of measurement data from the PPG sensor and the IMU sensor may be used to extract a feature set that uniquely identifies the user. In the present disclosure, a feature set may identify a unique pattern that associates a pattern of biometric data of a user with motion data of the user as collected using a number of sensors of a set of sensors.

In some embodiments, the machine-learning model that is trained to extract a feature set may be a neural network based machine-learning model, such as convolution neural network (CNN), deep neural network (DNN), and so on. By way of a non-limiting example, the machine-learning model based on the neural network may be a Siamese neural network. In some embodiments, the Siamese neural network may be trained using measurement data collected from a number of users. A subset of the measurement data may be used for training a machine-learning model and another subset of measurement data may be used for validation of the machine-learning model. In the present disclosure, the measurement data collected from a number of users and used for training a machine-learning model may be referenced as classified measurement data. Classified feature sets that correspond to the number of users may be identified using the machine-learning model. The classified feature sets thus act as support sets, which may identify the number of users.

In some embodiments, and by way of a non-limiting example, the machine-learning model that is based on the Siamese neural network may identify whether extracted feature sets from the fusion of measurement data match with any of the classified feature sets. Particularly, when a new user is needed to be authenticated, according to embodiments as described herein, a feature set corresponding to the new user is required to be added to the support sets. A process by which a feature set corresponding to the new user is added to the support sets is called an on-boarding process.

In some embodiments, during the on-boarding process, measurement data from at least two sensors from a set of sensors may be collected. Collected measurement data may be added to the support set and associated with the new user. In some embodiments, during the on-boarding process, the measurement data may be collected for a window of time. By way of a non-limiting example, the window of time may be about five seconds, ten seconds, or fifteen seconds (where “about” means±2.5 seconds). In some embodiments, each measurement data collected during the on-boarding process may be referenced as a shot, and thus the measurement data collected during the on-boarding process may be of a number of shots, such as, about five shots, ten shots, or fifteen shots (where “about” means±2.5 shots).

In some embodiments, authentication of the user may be performed using measurement data collected from at least two sensors of the set of sensors, and extracting a feature set from the collected measurement. A unit vector may be generated corresponding to the extracted feature set and compared with a unit vector corresponding to each feature set of the classified feature sets or support sets to determine similarity with a feature set of the classified feature sets. Accordingly, during authentication of the new user, using the fusion of measurement data from the at least two sensors of the set of sensors, a distance between the unit vector corresponding to a feature set extracted based on the measurement data and the unit vector corresponding to a feature set added to the classified feature sets during on-boarding on the new user may be required to be within a threshold distance range. In one example, the threshold distance may be greater than zero but less than a pre-configured threshold distance.

Accordingly, if the distance between the unit vector corresponding to the feature set extracted based on the measurement data and the feature set added to the support set or the classified feature sets during the on-boarding process is within the threshold distance range, the new user may be authenticated successfully based on the fusion of the biometric and motion data from the at least two sensors of the set of sensors, otherwise authentication of the new user may be determined as failed authentication. By way of a non-limiting example, when it is determined that authentication of the user has failed, the user may be authenticated using any one of other conventional means for authenticating a user, such as a password, a PIN, a design pattern, a fingerprint, and/or a facial recognition feature. Upon successful authentication of the user, based on the feature set extracted from the fusion of measurement data or any one of the other conventional means, the user may be allowed an access to a function, a feature, an application executing on the wearable electronic device, or any other resource of the wearable electronic device.

In some embodiments, a user who is granted access to a function, a feature, an application executing on the wearable electronic device, or any other resource of the wearable electronic device by authenticating using a password, a PIN, a design pattern, a facial recognition, a thumbprint, and so on, or based on biometric and motion measurement data from a set of sensors, may be periodically checked that the authenticated user is still operating the wearable electronic device. Accordingly, biometric and motion measurement data may be periodically, for example, every minute or every five minutes, collected by a set of sensors, as described herein, in accordance with some embodiments.

In some embodiments, on-boarding of a new user, for authentication using measurement data from at least two sensors of a set of sensors on the wearable electronic device, may require the new user to first authenticate using a password, a PIN, a design pattern, a facial recognition, a thumbprint, and so on. The new user may enter into an on-boarding mode by entering a command using an input interface of the wearable electronic device. In some examples, when a wearable electronic device is being set for the first time after being shipped from a factory or upon purchase by a user, the wearable electronic device may automatically enter into an on-boarding mode.

In some embodiments, when a feature set generated based on periodic measurements from the set of sensors indicates a distance between a unit vector corresponding to the feature set generated based on the periodic measurements and a feature set of the classified feature sets for the authenticated user is increasing over time, the feature set generated based on the periodic measurements from the set of sensors may be added to the classified feature sets and associated with the authenticated user. In some cases, a feature set included in the classified feature sets identifying the authenticated user may be replaced with the feature set generated based on periodic measurement, thereby avoiding a need for the user to be authenticated using a password, a PIN, a design pattern, a facial recognition, a thumbprint, and so on.

In some embodiments, a type of biometric data to be used for authentication may be selected by a user. Accordingly, a user may select a type of sensor, such as a PPG sensor, a heartrate sensor, an ECG sensor, a temperature sensor, and so on, to be used for collecting biometric data for authenticating the user in combination with the user's motion-related sensor data.

In some embodiments, biometric data may be collected using a sensor on a first wearable electronic device, and motion-related data may be collected using a sensor on a second wearable electronic device. The first and second wearable electronic devices may be communicatively coupled with each other, for example, using Wi-Fi, Bluetooth, and/or a near-field communication (NFC), and so on.

In some embodiments, a user may specify a sensitivity level and/or increased or decreased sensitivity of the authentication using the biometric and/or motion-related data generated from the sensors of the set of sensors. In some embodiments, the sensitivity level may be specified and/or increased or decreased by specifying a time duration for collecting measurement data. In some embodiments, and by way of a non-limiting example, a sensitivity level may be specified as a threshold distance between a vector corresponding to a feature set extracted based on measurement data and a feature set of the classified feature sets. As described herein, the classified feature sets include a feature set extracted based on measurement data from a set of sensors collected during on-boarding of the user.

In some embodiments, a wearable electronic device may be, for example, a phone, a watch, an ear bud, and so on. The wearable electronic device may include one or more processing units, an input/output mechanism (e.g., an input/output device, input/output port, or a button, a haptic output interface, or the combination thereof), a display (e.g., a light-emitting display), a memory or a storage device, a set of sensors including at least two sensors, and a power supply. The wearable electronic device is described in detail in the present disclosure.

In the present disclosure, various embodiments and alternatives thereof, and variations thereto, are discussed with reference to the drawings for purposes of explanation, and to facilitate an understanding of various configurations and constructions of a system. However, it will be apparent to one skilled in the art that some of the specific details presented herein may not be required in order to practice a particularly described embodiment, or an equivalent thereof.

FIG. 1A depicts a front view of an example wearable electronic device. In FIG. 1A, a front view 100A of an electronic device 102 is shown. The electronic device 102, as shown, may be a watch and have a crown 112 and a home button 110. An electronic device 102 may be worn by a user using a belt 104. A display 108 of the electronic device 102 may be used to provide an input from a user to a processor of the electronic device 102, and to display an output to the user.

FIG. 1B depicts a back view of the wearable electronic device shown in FIG. 1A. A back view 100B of the electronic device 102 is shown. As shown in FIG. 1B, a green light sensor 112a and an infrared sensor 112b along with a photodiode 112c may be disposed on the backside 114 touching skin of a user. The green light sensor 112a and the infrared sensor 112b, along with the photodiode 112c, may be used to measure and collect biometric data of a user, such as heartrate of a user. The electronic device 102 may also include other types of sensors to collect and measure motion-related data from a user, as described in detail below.

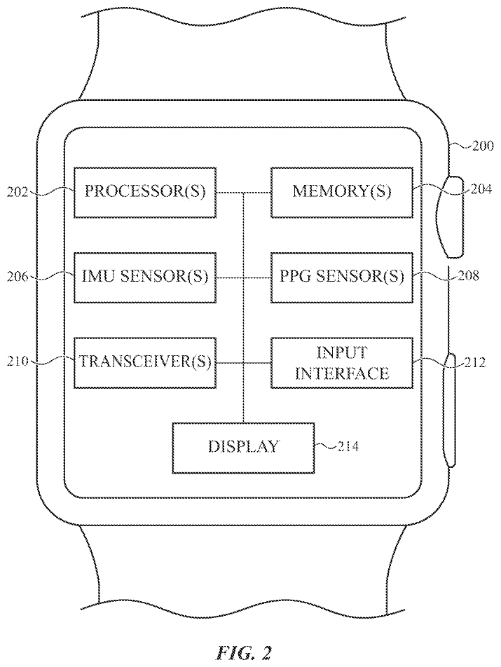

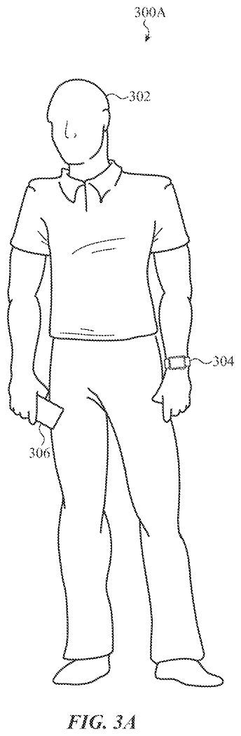

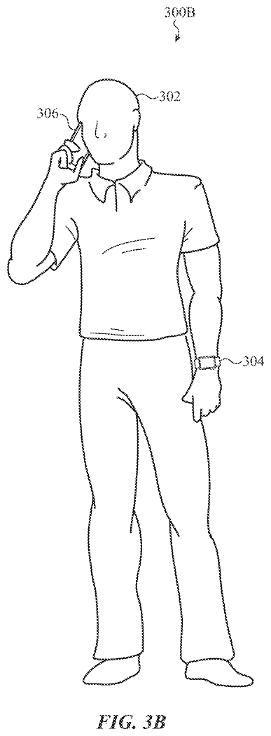

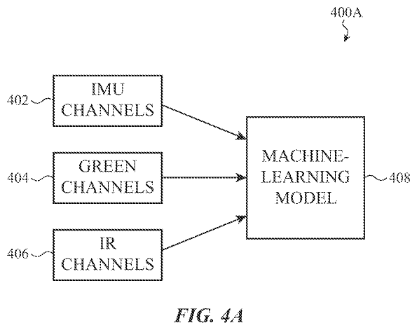

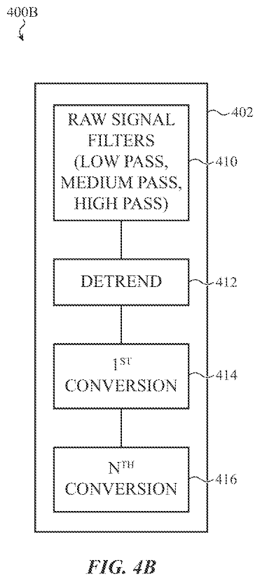

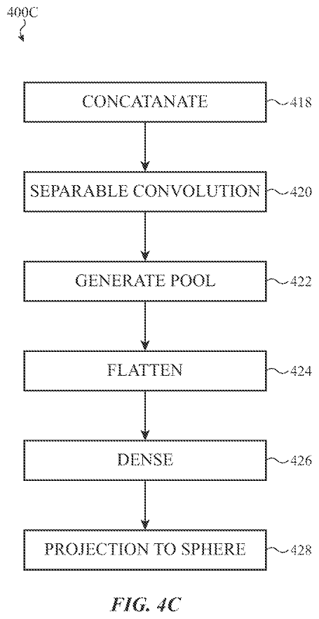

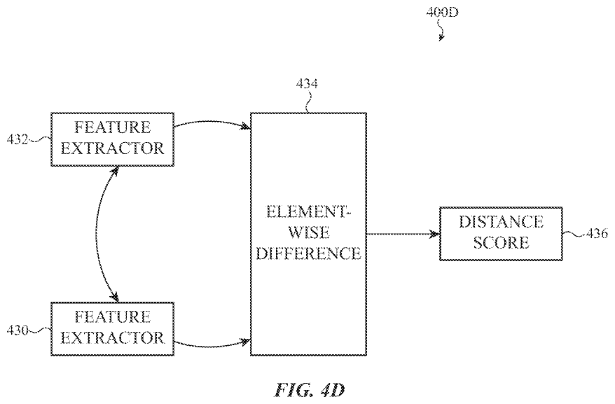

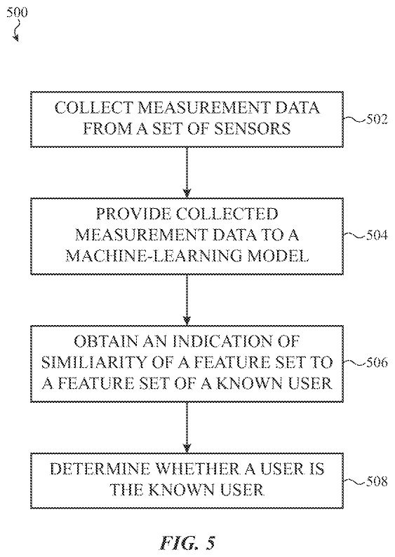

FIG. 2 depicts an example block diagram of the wearable electronic device shown in FIG. 1A and FIG. 1B, in accordance with some embodiments. A wearable electronic device 200 may include a processor 202, a memory 204, at least one inertia measurement unit (IMU) sensor 206, at least one PhotoPlethysmoGraphy (PPG) sensor 208, a transceiver 210, an input interface 212, and a display 214. Even though only one processor, one memory, and one transceiver are displayed in FIG. 2, there may be more than one processor, more than one memory, and/or more than one transceiver in the wearable electronic device 200.

The processor 202 can communicate, either directly or indirectly, with some or all of the components of the wearable electronic device 200. For example, a system bus or other communication mechanism can provide communication between the processor 202, a power supply (not shown), the memory 204, the at least one PPG sensor 208, the at least one IMU sensor 206, the transceiver 210, the input interface 212, and the display 214.

The processor 202 may be implemented as any electronic device capable of processing, receiving, or transmitting data or instructions. By way of a non-limiting example, the processor 202 may be a microcontroller, a microprocessor, a central processing unit, an application-specific integrated circuit, an integrated circuit, a field-programmable gate array, a digital signal processor, and/or a system-on-chip (SoC), and so on. Accordingly, the term “processor” and similar terms and phrases is meant to encompass a single processor or processing unit, multiple processors, multiple processing units, or other suitably configured computing element or elements.

In some embodiments, various components of the wearable electronic device 200 may be controlled by multiple processing units. For example, select components of the wearable electronic device (e.g., a sensor) may be controlled by a first processing unit, and other components of the electronic device (e.g., the display) may be controlled by a second processing unit, where the first and second processing units may or may not be in communication with each other.

By way of a non-limiting example, in some embodiments, an input may be processed through one or more processors. Each processor of the number of processors may process the received input according to the instruction set corresponding to that processor and then may forward or send a command to other processors for further processing.

In some embodiments, the power supply may be implemented with any device capable of providing energy to the electronic device. For example, the power supply may be one or more batteries or rechargeable batteries. By way of a non-limiting example, the power supply may be a power connector or power cord that connects the electronic device to another power source, such as a wall outlet. In some embodiments, by way of a non-limiting example, the power supply may be implemented as a US B-powered power supply.

In some embodiments, the memory 204 may store electronic data that may be used by the electronic device. For example, the memory may store electrical data or content such as, for example, software instructions, algorithms, audio and video files, documents and applications, device settings and user preferences, timing signals, control signals, and data structures or databases. The memory 204 may be configured as any type of memory. By way of a non-limiting example, the memory may be implemented as random access memory, read-only memory, static random-access memory, Flash memory, removable memory, and/or a hard disk, and so on.

In some embodiments, the wearable electronic device 200 may include a set of sensors including at least one PPG sensor 208 and at least one IMU sensor 210. As described herein, the at least one PPG sensor 208 may collect biometric measurement data of a user of the wearable electronic device 200 while the wearable electronic device is worn by the user, and the at least one IMU sensor 206 may collect the user's motion-related data. In some embodiments, and by way of a non-limiting example, the set of sensors may include other types of sensors, such as a temperature sensor, a heart-rate sensor, and/or an ECG sensor to receive biometric measurement data of the user. The set of sensors may also include a number of optical sensors, such as an infrared sensor, a camera, and/or a visible light sensor.

In some embodiments, each sensor of a set of sensors may have multiple channels, and data received from each channel of the multiple channels of at least two sensors of the set of sensors may be processed, as described herein, for authenticating a user. In some embodiments, measurement data for at least one channel of multiple channels of a sensor may be sampled at a different sampling rate compared to at least one other channel of the multiple channels of the sensor.

In some embodiments, and by way of a non-limiting example, a set of sensors may include an infrared sensor and a visible light sensor. The infrared sensor and the visible light sensor may collect heartrate measurement data of a user wearing the wearable electronic device 200. The heartrate measurement data may be combined with measurement data from the at least one IMU sensor 206 to extract a feature set identifying a user of the wearable electronic device for authentication and other purposes. In some embodiments, the at least one IMU sensor may be an accelerometer, a magnetometer, and/or a gyroscope.

In some embodiments, and by way of a non-limiting example, one or more sensors of a set of sensors, as described in the present disclosure, may be positioned almost anywhere on the wearable electronic device. The one or more sensors may be configured to sense one or more types of parameters which, by way of a non-limiting example, may include pressure, light, touch, heat, movement, relative motion, heartrate, blood oxygen saturation, blood volume change, and/or biometric data (e.g., biological parameters), and so on.

By way of a non-limiting example, in some embodiments, the one or more sensors may include a force sensor, a heat sensor, a position sensor, a light or optical sensor, an accelerometer, a pressure transducer, a gyroscope, a magnetometer, a health monitoring sensor, a PPG sensor, an ECG sensor, and so on. Additionally, the one or more sensors may utilize any suitable sensing technology, including, but not limited to, capacitive, ultrasonic, resistive, optical, ultrasound, piezoelectric, and thermal sensing technology.

In some embodiments, an I/O mechanism, including the input interface 212 and the display 214, may transmit and/or receive data from a user or another electronic device. Accordingly, the I/O mechanism may include a display, a touch sensing input surface, one or more buttons (e.g., a graphical user interface “home” button, a physical button such as a tact switch button), one or more cameras, one or more microphones or speakers, one or more ports such as a microphone port, and/or a keyboard. In some embodiments, by way of a non-limiting example, an I/O mechanism or port can transmit electronic signals via a communications network, such as a wireless and/or wired network connection using the transceiver 210. Examples of wireless and wired network connections include, but are not limited to, cellular, Wi-Fi, Bluetooth, IR, and Ethernet connections. An I/O mechanism can also be a software-defined electromechanical button including a sensor to sense user input force, a haptic engine to generate tactile feedback to the user, and a digital circuit to generate button signals for other sub-blocks in the electronic device according to some embodiments, as described herein.

FIGS. 3A-3B depict an example use case of authenticating a user based on measurement data from a set of sensors, in accordance with some embodiments. As shown in FIG. 3A and FIG. 3B, 300A and 300B each shows a user 302 wearing a first wearable electronic device 304 and a second wearable electronic device 306. The first wearable electronic device 304 may be a watch and the second wearable electronic device 306 may be a phone. Even though two different types of wearable electronic devices are shown in FIG. 3A and FIG. 3B, the user 302 may be wearing only one of the first wearable electronic device 304 or the second wearable electronic device 306. Each of the first wearable electronic device 304 and/or the second wearable electronic device may include a processor, a memory, at least one PPG sensor, at least one IMU sensor, a display, an input interface, and a transceiver as shown in FIG. 2.

In some embodiments, and by way of a non-limiting example, the first wearable electronic device 304 may include at least one PPG sensor, and the second wearable electronic device 306 may include at least one IMU sensor. The first wearable electronic device 304 and the second wearable electronic device 306 may be communicatively coupled with each other using Wi-Fi, Bluetooth, and/or a near-field communication (NFC), and so on.

As described herein, in accordance with some data, at least one PPG sensor (or any type of sensor that can collect biometric data from a user) of the first wearable electronic device 304 and/or the second wearable electronic device 306 may collect biometric data from the user 302, and at least one IMU sensor of the first wearable electronic device 304 and/or the second wearable electronic device 306 may collect motion-related data of the user 302. As shown in FIG. 3A, while the user 302 wearing the first wearable electronic device 304 and/or the second wearable electronic device 306 is in a first pose, for example, with hands down, the user may be, for example, in a second pose, bringing the second wearable electronic device 306 close to the face of the user 302, as shown in FIG. 3B.

A particular movement demonstrated by the user 302 while bringing the wearable electronic device 304 or 306 from the first pose to the second pose may be distinguishable from other users. Similarly, biometric data, for example, heartrate pattern of the user 302 may be distinguishable from other users. Accordingly, fusion of measurement data for the at least one IMU sensor and the at least one PPG sensor may be used to identify and distinguish a user from other users with a higher accuracy.

As described herein, biometric data collected from a sensor of one wearable electronic device may be used in combination with motion data collected from a sensor of another wearable electronic device.

FIG. 4A depicts a feature extractor architecture 400A, in accordance with some embodiments. As shown in FIG. 4A, measurement data may be collected from a set of sensors including at least one sensor to collect biometric data and at least one sensor to collect motion-related data of a user. As described herein, biometric data may be collected using a PPG sensor. In some embodiments, and by way of a non-limiting example, an optical sensor may also be used to collect biometric data of a user. The optical sensor may include an infrared sensor and a visible light sensor. Each sensor of the set of sensors may include multiple channels to receive data. As shown in FIG. 4A, a feature extractor architecture 400A may include multiple IMU channels 402 of one or more IMU sensors, multiple green channels 404 of one or more visible light sensors, and multiple infrared (IR) channels 406 of one or more IR sensors. Measurement data collected over the multiple IMU channels 402, the multiple green channels 404, and the multiple IR channels 406 may be provided as a combined input to a machine-learning model 408.

In some embodiments, and by way of a non-limiting example, the machine-learning model 408 may be a trained machine-learning module. By way of a non-limiting example, the machine-learning model 408 may be a neural network based machine-learning module, such as a convolution neural network, a deep neural network, a Siamese neural network, and so on. Biometric measurement data and motion-related measurement data received by the machine-learning model 408 may be processed to identify a feature set based on the received biometric and motion-related measurement data of a user.

In the present disclosure, the machine-learning model 408 that is based on a Siamese neural network is discussed in detail. However, various embodiments described herein are not limited to the Siamese neural network. The Siamese neural network-based machine-learning model 408 may be trained to identify a similarity between a feature set that is extracted based on measurement data received from a set of sensors, for example, via the multiple IMU channels 402, the multiple green channels 404, and the multiple IR channels 408, and classified feature sets. As described herein, the classified feature sets includes feature sets, which are based on measurement data collected from a set of users and used for training the machine-learning model 408, and a feature set based on measurement data collected during on-boarding of a user.

As described herein, in some embodiments, a similarity between a feature set that is extracted based on measurement data received from a set of sensors and a feature set of the classified feature sets may be determined by converting each feature set into a corresponding unit vector. A distance between a unit vector corresponding to a feature set that is extracted based on measurement data received from a set of sensors and a unit vector corresponding to a feature set of the classified feature sets may be measured. A unit vector of a feature set of the classified feature sets having the shortest distance from a unit vector corresponding to a feature extracted based on the measurement data may be then checked to verify whether the feature set of the classified feature set is a feature set that is added to the classified feature sets during on-boarding of the user. If the feature set of the classified feature set is the feature set that is added to the classified feature sets during on-boarding of the user, then the user is successfully authenticated based on the fusion of measurement data from the set of sensors. An indication identifying that the user is successfully authenticated may be generated, and upon receiving the indication of successful authentication of the user, the authenticated user may be granted an access to a function, a feature, an application executing on the wearable electronic device, or any other resource of the wearable electronic device.

In some embodiments, and by way of a non-limiting example, a similarity between a feature set that is extracted based on measurement data received from a set of sensors and a feature set of the classified feature sets may be determined using a triplet loss function. While using the triplet loss function, the similarity between a feature set extracted based on measurement data received from a set of sensors and another feature set of the classified feature sets may be determined by comparing a distance between a unit vector corresponding to a feature set that is extracted based on measurement data received from a set of sensors and two other unit vectors corresponding to two feature sets of the classified feature sets. One unit vector of two other unit vectors corresponding to two feature sets of the classified feature sets may have the shortest distance from the unit vector corresponding to a feature set extracted based on measurement data in comparison with another unit vector of the two other unit vectors.

FIG. 4B depicts an example process flow 400B of sensor data of the feature extractor architecture shown in FIG. 4A, in accordance with some embodiments. As shown in FIG. 4B, processing of measurement data, for example, via multiple IMU channels is shown in detail. Processing of measurement data from the multiple green channels and/or the multiple IR channels may be similar to the processing of measurement data of the multiple IMU channels.

In some embodiments, and by way of a non-limiting example, measurement data from the multiple IMU channels may be received as time series data. The received measurement data as time series measurement data may be first filtered to remove outliers using one or more raw signal filters 410. The one or more raw signal filters 410 may be Butterworth filters including a low pass filter, a medium pass filter, and/or a high pass filter. For example, multiple IMU channel signals and the multiple IR channel signals may be filtered having pass band spectrums for the low pass filter, the medium pass filter, and the high pass filter of 0.25-8 Hz, 8-32 Hz, and more than 32 Hz, respectively. Similarly, for the multiple green channel signals, a low pass filter, a first and a second medium pass filter, and a high pass filter may be of 0.25-2 Hz, 2-8 Hz, 8-32 Hz, and more than 32 Hz, respectively.

In some embodiments, multiple IMU channels may include six IMU channels with signals sampled at 100 Hz frequency. Of the six IMU channels, three channels may be from an accelerometer, and three channels may be from a gyroscope. Similarly, multiple IR channels may include two IR channels sampled at 64 Hz, and multiple green channels may include eight green channel samples at 256 Hz.

The filtered raw signals may then be detrend 412 to remove any trend effect and to determine only differences from the trend. Accordingly, any particular pattern may be identified. The detrend measurement data may then be processed through multiple conversions, such as, a first conversion 414, and an Nth conversion 416, to identify a particular feature set, and its corresponding unit vector.

FIG. 4C depicts an example machine-learning model of the feature extractor architecture shown in FIG. 4A, in accordance with some embodiments. A machine-learning model 400C shown in FIG. 4C may describe a machine-learning model for feature embedding. As described herein and using FIG. 4B, a feature may be extracted using a feature extractor architecture shown in FIG. 4A. Each feature may then be concatenated at 418 to generate a concatenated output from all channels (e.g., multiple IR channels, multiple green channels, and multiple IMU channels), and processed through a separable convolution layer 420, followed by pooling that is shown in FIG. 4C as generate pool 422, and generating a unit vector from processing through a flatten layer 424. By way of a non-limiting example, pooling may be max pooling, an average pooling, and so on.

The generated unit vector corresponding to the extracted feature set may then be processed through a dense layer 426 so that the machine-learning model may easily identify a relationship between the collected measurement data used for extracting a feature and generating a unit vector. The output of the dense layer 426 may then be processed and projected to sphere 428 to transform data from Euclidean space to hyper-spherical space to analyze using the triplet loss function with the Siamese neural network, as described herein, in accordance with some embodiments.

FIG. 4D depicts an example neural network 400D, in particular, a Siamese neural network, of the feature extractor architecture shown in FIG. 4A, in accordance with some embodiments. As shown in FIG. 4D, a feature set extracted from measurement data received via at least two sensors of a set of sensors, for example, an IMU sensor and a PPG sensor, may be compared with a feature set from classified feature sets. As shown in FIG. 4D, a first feature extractor 430 and a second feature extractor 432 may have a shared weight. The first feature extractor 430 may extract a feature set from measurement data received via at least two sensors of a set of sensors, for example, an IMU sensor and a PPG sensor, and the second feature extractor 432 may extract a feature from classified feature sets. The classified feature sets may include feature sets that are used during training of a machine-learning algorithm and a feature set added to the classified feature sets during on-boarding of a user.

The machine-learning algorithm, e.g., the Siamese neural network, may then compute a distance score 436 based on an element-wise difference of the two feature sets as input from the first feature extractor 430 and the second feature extractor 432.

As described herein, during on-boarding of a new user, measurement data may be collected from a user, for example, for a window of time, and a feature set may be extracted from the collected measurement data. The feature set extracted during the on-boarding process may then be added to the classified feature sets and may be marked to identify that the feature set is associated with a particular user and added during the on-boarding process. Subsequently, if a feature set extracted from measurement data matches with a feature set of the classified feature sets that is associated with the particular user and added during the on-boarding process, the user may be successfully authenticated using the biometric and motion-related data associated with the user.

FIG. 5 depicts an example flow chart depicting operations for authenticating a user based on fusion of measurement data from a set of sensors, in accordance with some embodiments. As shown in FIG. 5, a flow chart 500 includes operations for authenticating a user based on fusion of measurement data from a set of sensors. At 502, measurement data from a set of sensors of an electronic device may be received by a processor while the electronic device is worn by a user. The electronic device thus may be a wearable electronic device, such as a phone, a watch, an earbud, and so on. In some embodiments, and by way of a non-limiting example, a set of sensors may include at least one sensor for measuring and/or collecting biometric data of a user and at least one sensor for measuring and/or collecting motion-related data of the user. By way of a non-limiting example, the at least one sensor for measuring and/or collecting biometric data and the at least one sensor measuring and/or collecting motion-related data may be in a single wearable electronic device or different wearable electronic devices. In the case, when the biometric data and the motion-related data of the user are being collected by a sensor in different wearable electronic devices, one wearable electronic device may transmit measurement data of a sensor to another wearable electronic device for processing by a processor of the other wearable electronic device.

In some embodiments, at least one sensor for measuring biometric data may include a temperature sensor, a heartrate sensor, a PhotoPlethysmoGraphy (PPG) sensor, or an ElectroCardioGram (ECG) sensor, and so on, and at least one sensor for measuring motion-related data may be an IMU sensor including an accelerometer, a magnetometer, and/or a gyroscope. By way of a non-limiting example, multiple optical sensors including a visible light sensor and an infrared sensor may be used to measure heartrate of a user.

At 504, measurement data collected from the set of sensors and previously collected sets of measurement data for a user obtained during the on-boarding process of the user may be provided to a machine-learning model. The machine-learning model may be a trained machine-learning model that extracts a feature set from a fusion of the measurement data received by the processor at 502 from the set of sensors and determines a similarity of the feature set to each of a number of classified feature sets. As described herein, the classified feature sets include feature sets based on measurement data used for training of the machine-learning model. The training of the machine-learning model may, therefore, be an offline training. In other words, measurement data used for training of the machine-learning model may be received from a number of users that is different from a user being authenticated after a user on-boarding process.

A feature set may be extracted using a trained machine-learning model, which may be a neural network-based machine learning model. By way of a non-limiting example, the neural network may be a Siamese neural network. The Siamese neural network may then generate an indication of whether the extracted feature set is similar to the one of the classified feature sets based on a distance between a first vector generated corresponding to the extracted feature set and at least one second vector generated corresponding to at least one of the classified feature sets. If similarity is found between the extracted feature set and a feature set that was added to the classified feature during a user on-boarding process, then the indication may identify the user as a user added during the on-boarding process (e.g., a known user).

At 506, the indication generated at 504 may be received by the processor. The indication may suggest whether the extracted feature set is similar to one of the classified feature sets added during on-boarding of a new user or one of the classified feature sets based on measurement data used for training of the machine-learning model. At 508, based on the received indication, the processor may determine if the user is a known user identified based on a feature set added to the classified feature set during an on-boarding process or a user that is associated with a feature set used for training of the machine-learning algorithm.

As described herein, in accordance with some embodiments, upon identifying the user as the known user, the user may be granted access to a function, a feature, an application executing on the wearable electronic device, or any other resource of the wearable electronic device. If the user is not identified as the known user, the user may be authenticated using any one of other conventional means for authenticating a user, such as a password, a PIN, a design pattern, a fingerprint, and/or a facial recognition feature.

In some embodiments, and by way of a non-limiting example, a number of users that can be authenticated according to embodiments as described herein may be configurable. For example, a number of users that can be authenticated based on a fusion of the biometric and motion-related data of a user may be two users. Accordingly, a number of feature sets that may be required to be compared may be limited to the two feature sets that were added during the on-boarding process. Accordingly, authentication of a user may be made faster.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

The present disclosure recognizes that personal information data, including biometric data, in the present technology, can be used to the benefit of users. For example, the use of biometric authentication data can be used for convenient access to device features without the use of passwords. In other examples, user biometric data is collected for providing users with feedback about their health or fitness levels. Further, other uses for personal information data, including biometric data, that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure, including the use of data encryption and security methods that meets or exceeds industry or government standards. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data, including biometric data. That is, the present disclosure contemplates that hardware and/or software elements can be provided to prevent or block access to such personal information data. For example, in the case of biometric authentication methods, the present technology can be configured to allow users to optionally bypass biometric authentication steps by providing secure information such as passwords, personal identification numbers (PINS), touch gestures, or other authentication methods, alone or in combination, known to those of skill in the art. In another example, users can select to remove, disable, or restrict access to certain health-related applications collecting users' personal health or fitness data.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed and aggregated only for legitimate, agreed-upon, and reasonable uses.

As used herein, the term “processor” (along with other similar terms and phrases, including, but not limited to, “processor core”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example electronic devices or components that can include a processor core as described herein include, but are not limited to: single or multi-core processors; single or multi-thread processors; purpose-configured co-processors (e.g., graphics processing units, motion processing units, sensor processing units, and the like); volatile or nonvolatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

More generally, as described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

What is claimed is:

1. A method comprising:
collecting, by a processor of an electronic device and while the electronic device is worn by a user, measurement data from a set of sensors of the electronic device;
providing, by the processor and to a machine-learning model,
the collected measurement data from the set of sensors; and
previously collected sets of measurement data for a known user, the machine-learning model extracting a feature set from a fusion of the measurement data obtained by the set of sensors and determining a similarity of the feature set to each of a number of classified feature sets, the classified feature sets generated based on classified measurement data;
obtaining, by the processor, an indication of whether the extracted feature set is similar to one of the classified feature sets, wherein at least one of the classified feature sets is classified as belonging to the known user and generated based on the previously collected sets of measurement data for the known user; and
based on the obtained indication, determining, by the processor, whether the user is the known user.

2. The method of claim 1, wherein the machine-learning model is based on a trained neural network.

3. The method of claim 2, wherein the neural network is a Siamese neural network.

4. The method of claim 1, wherein the previously collected sets of measurement data are acquired during onboarding of the known user, and the measurement data from the set of sensors is acquired during authentication of the known user.

5. The method of claim 1, wherein the set of sensors includes:
at least one of a temperature sensor, a heartrate sensor, a PhotoPlethysmoGraphy (PPG) sensor, or an ElectroCardioGram (ECG) sensor; and
at least one inertial measurement unit (IMU) sensor including an accelerometer, a magnetometer, or a gyroscope.

6. The method of claim 5, wherein the set of sensors further includes a number of optical sensors.

7. The method of claim 6, wherein the number of optical sensors includes an infrared sensor and a visible light sensor.

8. The method of claim 7, wherein the measurement data from the set of sensors includes data from two or more channels of the infrared sensor, data from two or more channels of the visible light sensor, and data from two or more channels of the at least one IMU sensor.

9. The method of claim 1, further comprising generating the indication of whether the extracted feature set is similar to the one of the classified feature sets based on a distance between a first vector generated corresponding the extracted feature set and at least one second vector generated corresponding to at least one of the classified feature sets.

10. The method of claim 1, further comprising generating the indication of whether the extracted feature set is similar to the one of the classified feature sets based on a triplet loss function using a first vector generated corresponding to the extracted feature set, and a second and a third vector generated corresponding to the classified feature sets.

11. The method of claim 1, further comprising tuning a machine-learning model sensitivity in response to a number of the previously collected sets of measurement data for the known user.

12. The method of claim 11, wherein tuning the machine-learning model sensitivity comprises collecting the measurement data from the set of sensors over a window of time.

13. The method of claim 12, wherein the window of time is about five seconds, ten seconds, or fifteen seconds.

14. A wearable electronic device, comprising:
a memory configured to store instructions;
a set of sensors including at least two sensors; and
a processor configured to execute the instructions stored in the memory, which causes the processor to perform operations comprising:
collecting measurement data from the set of sensors while the wearable electronic device is worn by a user;
providing, to a trained machine-learning model,
the collected measurement data from the set of sensors; and
previously collected sets of measurement data for a known user, the trained machine-learning model extracting a feature set from a fusion of the measurement data obtained by the set of sensors and determining a similarity of the feature set to each of a number of classified feature sets, the classified feature sets generated based on classified measurement data; and
determining whether the user is the known user based on a comparison of the extracted feature set with each of the number of the classified feature sets, at least one of the number of classified feature sets classified as belonging to the known user and generated based on the previously collected sets of measurement data for the known user.

15. The wearable electronic device of claim 14, wherein the operations further comprise:
in response to determining that the user is not the known user, requesting the user to authenticate using any one of: a password, a PIN, a design pattern, a fingerprint, or a facial recognition feature.

16. The wearable electronic device of claim 14, wherein the operations further comprise, in response to determining that the user is the known user, allowing the user access to a function of the wearable electronic device.

17. The wearable electronic device of claim 14, wherein the measurement data is collected by sampling the measurement data from a number of channels of the at least two sensors of the set of sensors.

18. The wearable electronic device of claim 17, further comprising sampling a first subset of channels of the number of channels of a sensor of the at least two sensors at a first sampling rate and a second subset of channels of the number of channels of the sensor of the at least two sensors at a second sampling rate.

19. A system, comprising:
a first wearable electronic device comprising at least one PhotoPlethysmoGraphy (PPG) sensor;
a second wearable electronic device comprising at least one Inertial Measurement Unit (IMU) sensor; and
a processor configured to:
collect measurement data from the at least one PPG sensor and the at least one IMU sensor while the first and second wearable electronic devices are worn by a user;
provide, to a machine-learning model,
the collected measurement data from the set of sensors; and
previously collected sets of measurement data for the known user, the machine-learning model trained for extracting a feature set from a fusion of measurement data obtained by a set of sensors and determining a similarity of the feature set to each of a number of classified feature sets, the classified feature sets generated based on classified measurement data, wherein at least one of the classified feature sets is classified as belonging to a known user; and
determine whether the user is the known user based on a comparison of the extracted feature set with each of the number of the classified feature sets, at least one of the number of the classified feature sets classified as belonging to the known user and generated based on the previously collected sets of measurement data for the known user.

20. The system of claim 19, wherein the measurement data is collected by sampling the measurement data from a number of channels of the at least one PPG sensor or the at least one IMU sensor at different sampling rates.
